(19) United States
(12) Patent Application Publication
(10) Pub. No.: US 2017/0122770 A1
(43) Pub. Date: May 4, 2017

(54) METHOD AND SYSTEM FOR PROVIDING DYNAMIC ERROR VALUES OF DYNAMIC MEASURED VALUES IN REAL TIME

(71) Applicant: Continental Teves AG & Co. oHG, Frankfurt (DE)

(72) Inventor: Nico Steinhardt, Frankfurt (DE)

(73) Assignee: Continental Teves AG & Co. oHG, Frankfurt (DE)

(21) Appl. No.: 15/374,451

(22) Filed: Dec. 9, 2016

Related U.S. Application Data
(63) Continuation of application No. PCT/EP2015/062792, filed on Jun. 9, 2015.

(30) Foreign Application Priority Data
Jun. 11, 2014 (DE) 10 2014 211 177.3

(51) Int. Cl. G01C 25/00; G01C 22/02; G01C 21/16; G01D 21/00; G01C 21/20

(52) U.S. Cl. CPC G01C 25/00; G01D 21/00; G01C 21/20; G01C 21/165; G01C 22/02

(57) ABSTRACT

A method is for providing dynamic error values of dynamic measured values in real time, wherein the measured values are recorded using at least one sensor system, wherein the measured values directly or indirectly describe values of physical variables, wherein the values of indirectly described physical variables are calculated from the measured values and/or from known physical and/or mathematical relationships, wherein the error values of the measured values from the at least one sensor system are determined, and wherein the error values are gradually determined in functional blocks which do not influence one another and are connected to form rows. The invention additionally relates to a corresponding system and to a use for the system.

### CROSS REFERENCE TO RELATED APPLICATIONS

This U.S. patent application claims the benefit of PCT patent application No. PCT/EP2015/062792, filed Jun. 9, 2015, which claims the benefit of German patent application No. 10 2014 211 177.3, filed Jun. 11, 2014, both of which are hereby incorporated by reference.

### TECHNICAL FIELD

The invention relates to a method and system for providing dynamic error values of dynamic measured values in real time for sensors systems in vehicles.

### BACKGROUND

In a so-called virtual sensor, the otherwise direct connection between sensors and user functions is separated. This represents an intermediate plane in the system architecture. Safety-critical functions, in particular, depend on the fastest possible and reliable detection of errors and contradictions of measured data to ensure their function and specified safety level, e.g. in accordance with the so-called automotive safety integrity level (ASIL). The described separation of the functions from the sensors assigned to them typically no longer allows such a check by the function, but it provides the potential for faster detection and improved quality of error detection through access to multiple redundant sensors. Furthermore, it is known that the quality of both the merged data and of error detection depends on the current availability and the quality of measurement of the sensors included in the data fusion.

In this context, patent specification DE 10 2012 219 478 A1 describes a sensor system for independently evaluating the integrity of its data. The sensor system is preferably used in motor vehicles and includes multiple sensor elements that are in a form to sense at least to some extent different primary measured variables or use at least to some extent different measurement principles. The sensor system further includes a signal processing device which evaluates the sensor signals at least to some extent collectively and at the same time rates the information quality of the sensor signals. The signal processing device further provides a piece of information about the consistency of at least one datum of a physical variable, wherein the datum of the physical variable is calculated at least to some extent on the basis of the sensor signals from sensor elements that sense the physical variable either directly or from the sensor signals from which the physical variable can be calculated. The information about the consistency of the datum is calculated on the basis of the directly or indirectly redundantly present sensor information.

Patent specification DE 10 2012 219 475 A1 discloses a sensor system for independently evaluating the integrity of its data, which is preferably used in motor vehicles. The sensor system includes multiple sensor elements that are in a form to sense at least to some extent different primary measured variables or use at least to some extent different measurement principles. The sensor system further includes a signal processing device which evaluates the sensor signals at least to some extent collectively and at the same time rates the information quality of the sensor signals. The signal processing device further provides a piece of information about the accuracy of at least one datum of a physical variable in the form of a characteristic quantity or a set of characteristic quantities. This characteristic quantity or this set of characteristic quantities is provided after or at successive signal processing steps, and the data of the characteristic quantity or of the set of characteristic quantities are dependent on how the associated or the preceding signal processing step influences that processed datum of the physical variable.

Patent specification DE 10 2010 063 984 A1 discloses a sensor system including a plurality of sensor elements. The sensor elements are in a form to detect at least to some extent different primary measured variables or use at least to some extent different measurement principles. Other measured variables are then derived at least partially from the primary measured variable of the sensor elements. The sensor system further includes a signal processing device, an interface device, and a plurality of functional devices. The sensor elements and all functional devices are connected to the signal processing device. The primary measured variables also provide redundant pieces of information which are compared in the signal processing device or can support one another. Conclusions on the reliability and accuracy of the observables can be drawn from the comparison of the observables calculated in different ways, such that faulty measurements can be filtered out. The signal processing device qualifies the accuracy of the observables and provides the observables together with accuracy information via an interface device to various functional devices.

Information about the overall uncertainty of the totality of merged data, as it is known from the prior art, is insufficient for building control or closed-loop control systems in user functions, such as a navigation system for motor vehicles that provides accurate lane information, based on the dynamic quality of a data fusion. Instead, there is a need that a virtual sensor outputs information about various individual characteristics and individual accuracies of sensor signals in real time, thus providing a so-called dynamic data sheet for the respective functions.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

It is an object of the invention to propose a method for providing dynamic error values of dynamic measured values in real time.

The invention relates to a method for providing dynamic error values of dynamic measured values in real time, wherein the measured values are detected using at least one sensor system, wherein the measured values directly or indirectly describe values of physical variables, wherein the values of indirectly described Physical variables are calculated from the measured values and/or from known physical and/or mathematical relationships, wherein the error values of the measured values from the at least one sensor system are determined, and wherein the error values are gradually determined in function blocks which do not influence one another and are connected to form rows.

This results in an accuracy calculation made possible in which error values are divided into characteristics typical of data sheets, such as noise, offset, or scale factor errors, by independent function blocks, preferably modeled as a so-called black box. Each function block can include the error propagation calculation of any one or several calculation steps of the system to be described. The input variables and output variables of each function block, that is, the incoming measured values and the outgoing measured values or error values preferably are characteristics needed for a theoretical model. The function block structure according to the invention also allows a flexible, branching, and adjustable course of the signal path. A preferably existing application of compensation measurements and of different parameters from the sensor system described by the propagation calculation is preferably modeled likewise.

The function blocks are free of reciprocal effects, that is, they do not influence one another. They also do not influence any existing fusion filters.

The division into one or several rows of function blocks according to the invention allows an easy and flexible change of the processing steps. Furthermore, the so-called “data sheet description” of the processed measured values can be used after each individual calculation step or each individual function block, respectively, and the entire data processing is thus substantially completely described by lining up the individual function blocks. Branching of the row or rows of function blocks and, where required, the influence of other parameters and measured values, such as correction values of a fusion filter, can be relatively easily introduced without changing the overall modeling. The output data or measured values or error values, respectively can be used for example for filtering or closed-loop control. Thus, a propagation calculation for a complete signal processing modeling can be achieved by the actual physical connection of the data buses and further coordination is not required.

In other words, one embodiment of the method allows a comparatively detailed description of the measured values or error values at almost any point in time during processing. This also makes it easier to provide the measured values or error values needed for different user functions in a respectively required or useful phase.

Furthermore, one embodiment of the method allows the detection of interferences and inconsistencies of the measured values or error values or physical variables, respectively, in the shortest possible time and their output as an unambiguous statement. In addition, information about the stochastic uncertainty and sharpness of this statement can be calculated comparatively easily and particularly preferably passed on to the user functions as an integrity evaluation. In order to meet these requirements, the quality evaluation is preferably divided into the criteria “integrity” and “accuracy”. Integrity is the measure of confidence in the correctness of measured values or error values or physical variables within their measuring accuracy, and the stochastic evaluation of specific properties of measured values across the entire processing sequence or row of function blocks. Another requirement to be met by both parts is that the algorithms for integrity and accuracy evaluation can be integrated consistently and in real time, e.g. a fusion filter.

According to an embodiment, the physical variables are normal or Gaussian distributed.

According to another embodiment, the function blocks each perform an error propagation calculation. The error values are thus step-by-step determined by the function blocks and in particular separately from the processing in other function blocks.

According to another embodiment, the error propagation calculation in each function block is individually characterized by the respective sensor systems and/or individually characterized by the respective physical variables. This allows individually adapted and specific treatment of the measured values or error values or physical variables, which eventually results in improved integrity and improved accuracy of the individual error values determined.

According to another embodiment, the error values in the function blocks are treated as mathematical matrices. This allows a handling of error values which is as simple as it is comprehensive and efficient.

According to another embodiment, the error values are assigned at least on a proportionate basis to the values of physical variables in the fusion dataset. This has the advantage that a connection between the error values and the physical variables can be provided for the user functions. This means that the actual error values are determined, not just variances.

According to another embodiment, the static fault characteristics of the sensor systems each represent a first function block in a row, wherein at least one row starts from each first function block. This allows the inaccuracy of a sensor system to be determined in a comparatively simple manner. Starting from the static fault characteristics, it is preferred that the dynamic fault characteristics of the sensor systems, such as temperature influences and temperature compensations, are stated in the further sequence of the row of function blocks.

According to another embodiment, the function blocks each provide the raw data for other function blocks and/or for applications based on the sensor systems. In this way, a row of function blocks of any length with any number of branches can be represented in a simple manner.

According to another embodiment, the error values include measurement noise and/or a zero point error and/or a scale factor error. Measurement noise, a zero point error, and a scale factor error are those errors that mainly contribute to the occurrence of faults. If these are taken into account when determining the error values, or if the error values include these errors, the error values become more reliable and more accurate.

According to another embodiment, at least one row of connected function blocks bifurcates. This allows processing of the raw data of one function block in different ways, namely, by other function blocks.

According to another embodiment, the measured values and/or the error values are merged into a fusion dataset by means of a data fusion. A joint fusion dataset is typically more reliable and more accurate compared to individual measured values and/or individual error values, and by determining the error values it particularly allows a comparatively reliable evaluation of the accuracy or reliability of the merged measured values and/or the merged error values.

According to another embodiment, the measured values and/or the error values that are merged into a fusion dataset are corrected. This results that the determination of the error values has a distinct significance, namely the subsequent correction of the error values. This improves the measured values determined by the sensor system and makes them more precise. But it is likewise possible to detect and correct the error values of a suitable stochastic model, wherein the model takes account of the individual properties of the respective sensor system.

According to another embodiment, the measured values are at least measured values of an inertial sensor system, measured values of a global satellite sensor system, and/or measured values of an odometry sensor system. This makes the invention particularly suitable for navigation purposes and navigation systems, preferably in motor vehicles. The sensor systems, i.e. the inertial sensor system or satellite navigation system or odometry navigation system, thus determine the position, particularly the position of a motor vehicle, as a physical variable from the measurements. The global satellite navigation system can be a so-called GPS navigation system, for example. The odometry navigation system first determines the speed e.g. using the rolling circumference of the motor vehicle tires, and the position can then be determined by dead reckoning, taking account the steering angle into account. It is particularly useful that the satellite navigation system includes at least two satellite signal receivers. This improves the quality of the satellite signals detected and the accuracy of the satellite navigation system.

According to another embodiment, the orbits of satellites of the satellite system are assumed to be error free for calculating the values of indirectly described physical variables.

According to another embodiment, the inertial navigation system is the basic sensor system. Using the inertial navigation system as the basic sensor system has the advantage that, in comparison, it has the highest availability because it has a comparatively high output rate of the captured input data and works regardless of external disturbances.

A system for providing dynamic error values of dynamic measured values in real time, includes at least one sensor system and a fusion filter, wherein the at least one sensor system is configured to detect measured values. The measured values directly or indirectly describe physical variables, wherein the fusion filter is configured to calculate the values of indirectly described physical variables from the measured values and/or from known physical and/or mathematical connections, wherein the fusion filter is configured to merge the measured values into a fusion dataset using a data fusion, and wherein the system is configured to provide mutually non-interacting function blocks that are connected in rows. The function blocks are configured to determine the error values step by step. The system, thus, includes all devices necessary for executing the method. For example, the system according to the invention can include a processor and an electronic storage device on which a respective computer program product is stored and can be executed.

The system can be used in a motor vehicle.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein;

FIG. 1 shows an example of a possible embodiment of a system which is configured for determining the position in a motor vehicle;

FIG. 2 shows an example of another possible embodiment of a system which is also configured for determining the position in a motor vehicle; and

FIG. 3 shows an exemplary setup of function blocks connected in a row.

### DETAILED DESCRIPTION

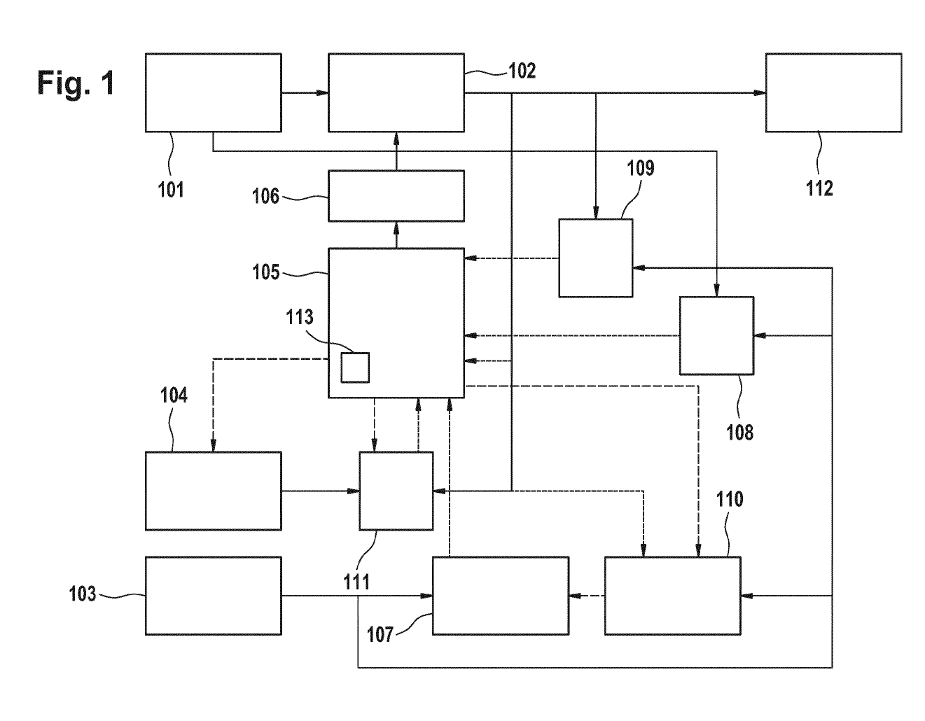

FIG. 1 is a schematic view of an embodiment of the system according to the invention, which is intended for installation and use in a motor vehicle (not shown). The system shown is configured for providing dynamic error values of an inertial navigation system in real time and is suitable for determining the position of the motor vehicle. All elements or components or sensor systems included in the system are shown as function blocks; the figure also shows their interaction.

The system of this example includes the inertial navigation system 101, which is configured such that it can at least detect the accelerations along a first, a second, and a third axis as well as at least the rotation rates about the first, the second, and the third axes. The first axis on the basis of the example is the longitudinal axis of the motor vehicle, the second axis the transverse axis of the motor vehicle, and the third axis is the vertical axis of the motor vehicle. These three axes form a Cartesian coordinate system, the so-called motor vehicle coordinate system.

The inertial navigation system 101 is the so-called basic sensor system whose output data are corrected using the other sensor systems described below. The correction systems are an odometry navigation system 103 and a satellite navigation system 104.

The system has a so-called strapdown algorithm unit 102 in which a so-called strapdown algorithm is executed with which the input data or measured values from the inertial navigation system 101 are converted, inter alia, in position data. The input data or measured values of the inertial navigation system 101, which naturally describe accelerations, are integrated twice over time. A single integration over time is used to determine the orientation and speed of the motor vehicle. The strapdown algorithm unit 102 also compensates a Coriolis force that acts on the inertial navigation system 101.

The raw data from the strapdown algorithm unit 102 includes the following physical variables: speed, acceleration, and the rotation rate of the motor vehicle relative to the three axes of the motor vehicle coordinate system mentioned and, additionally, related to a world coordinate system that is suitable for describing the orientation or dynamic variables of the motor vehicle in the world. The world coordinate system can for example be a GPS coordinate system. The raw data of the strapdown algorithm unit 102 also include the position relative to the motor vehicle coordinate system and the orientation relative to the world coordinate system. In addition, the raw data from the strapdown algorithm unit 102 show the variances as information about the data quality of the navigation information mentioned above. These variances are not calculated in the strapdown algorithm unit 102 but only used there and passed on. The navigation information mentioned above that is calculated by the strapdown algorithm unit 102 is made available to other motor vehicle systems via the output module 112.

The system may also include the odometry navigation system 103 in the form of wheel speed sensors for each wheel of the motor vehicle. For example, this is a four-wheel motor vehicle with four wheel speed sensors, each of which measuring the speed of their associated wheel and its rolling direction. The odometry navigation system 103 further includes a steering angle sensor element chat detects the steering angle of the motor vehicle.

In addition, the system shown as an example includes the satellite navigation system 104, which is configured to determine the distance between an assigned satellite and the motor vehicle and the respective speed between the assigned satellite and the motor vehicle.

A fusion filter 105 provides a fusion dataset 106 in the course of the joint evaluation of the input data or measured values from the odometry navigation system 103, the satellite navigation system 104, and the inertial navigation system 101. The fusion dataset 106 includes the various input data from the different sensor systems, wherein the fusion dataset 106 in addition includes error values and variances assigned to the error values, which describe the data quality.

The input data or measured values from the inertial navigation system 101 are stored for a predetermined period of time in a dedicated electronic data memory 113 of the fusion filter 105 during the operation of the motor vehicle. In this respect, the inertial navigation system 101 is the so-called basic sensor system, while the odometry navigation system 103 and the satellite navigation system 104 represent the so-called correction systems whose output data are used for correcting the measured values or physical variables of the basic sensor system. It is thus ensured that measured values or values of physical variables which were at least seemingly detected at an identical point in time can always be used for correcting the measured values or values of the physical variables.

The fusion data set 106 provided by the fusion filter 105 includes, based on the example, the quantitative errors of the basic sensor system determined using the plausibility checked output data of the correction systems.

The strapdown algorithm unit 102 now corrects the output data of the basic sensor system using the fusion data set 106. The fusion data set 106 is calculated by the fusion filter 105 from the input data or measured values, respectively, from the odometry navigation system 103, the satellite navigation system 104, and the inertial navigation system 101.

The fusion filter 105 is designed as an error state space Kalman filter, that is, as a Kalman filter that particularly performs a linearization of the measured values or values of the physical variables and in which the quantitative error values of the measured values or values of the physical variables are calculated or estimated and which works sequentially and corrects the available output data in the respective functional step of the sequence.

The fusion filter 105 is configured such that it always asynchronously detects the most current measured values or values of physical variables available from the inertial navigation system 101, the odometry navigation system 103, and the satellite navigation system 104. The measured values or values of physical variables are routed via the motor vehicle model unit 107 and the orientation model unit 109.

The vehicle model unit 107 is configured such that it calculates at least the speed along a first axis, the speed along a second axis, and the rate of rotation about the third axis from the measured values of the physical variables from the odometry system 103 and provides these to the fusion filter 105.

The system of this example may also include a tire parameter estimation unit 110, which is configured to calculate at least the radius, the dynamic radius on the basis of the example, of each wheel and additionally calculates the cornering stiffness and the slip stiffness of each wheel and provides them to the motor vehicle model unit 107 as additional input variables. The tire parameter estimation unit 110 is further configured such that it uses a substantially linear tire model for calculating the tire sizes.

The input variables of the tire parameter estimation unit 110 on the basis of the example are the wheel speeds and the steering angle, at least to some extent the output values from the strapdown algorithm unit 102, and the variances determined by the fusion filter 105.

The system of this example may also include the GPS error detection and plausibility check unit 111, which is configured, on the basis of the example, to receive the measured values or values of physical variables from the satellite navigation system 104 as input data and at least some output data from the strapdown algorithm unit 102 and takes these into account in its calculations. The GPS error detection and plausibility check unit 111 checks the measured values or values of the physical variables against a stochastic model adjusted to a satellite navigation system 104. If the measured values or values of the physical variables are consistent with the model within a tolerance that takes the noise into account, they will be checked for plausibility.

The GPS error detection and plausibility check unit 111 is in addition connected at data level to the fusion filter 105 and transfers the plausibility-checked input data to the fusion filter 105.

By way of example, the GPS error detection and plausibility check unit 111 is configured such that it carries out the following steps to select a satellite: measurement of position data for the vehicle relative to the satellite on the basis of the sensor signals from the satellite navigation system 104; determination of reference position data for the motor vehicle that are redundant with respect to the position data determined on the basis of the sensor signals from the satellite navigation system 104; selection of the satellite if a comparison of the position data and the reference position data satisfies a predetermined condition. A difference between the position data and the reference position data is formed for comparing the position data and the reference position data. The predetermined condition is a maximum permissible deviation between the position data and the reference position data. The maximum permissible deviation is dependent on a standard deviation that is calculated on the basis of a sum of a reference variance for the reference position data and a measurement variance for the position data, and wherein the maximum permissible deviation corresponds to a multiple of the standard deviation such that a probability that the position data are in a variation interval that is dependent on the standard deviation is below a predetermined threshold value.

The system of this example may also include a standstill detection unit 108 that is configured to detect the standstill of the motor vehicle and provides information from a standstill model at least to the fusion filter 105 if a standstill of the motor vehicle is detected. The information from the standstill model says that the rotation rates about all three axes have the value zero and that the speeds along all three axes have the value zero. Based on the example, the standstill detection unit 108 is configured to use as input data the measured values or values of the physical variables of the wheel speed sensors of the odometry navigation system 103 and the input data of the inertial navigation system 101.

On the basis of the example, the system uses a first group of input data that relate to a vehicle coordinate system and additionally uses a second group of input data that relate to a world coordinate system, wherein this world coordinate system is used particularly for describing the orientation and dynamic variables of the motor vehicle. The orientation model unit 109 is used to determine an orientation model between the motor vehicle coordinate system and the world coordinate system.

The orientation angle between the motor vehicle coordinate system and the world coordinate system determined by the orientation model unit 109 is determined on the basis of the following physical variables: the vector speed relative to the world coordinate system, the vector speed relative to the motor vehicle coordinate system, the steering angle, and the respective quantitative error of the raw data that describe said variables.

The orientation model unit 109 relies on all the measured values or values of the physical variables from the strapdown algorithm unit 102. Based on the example, the orientation model unit 109 is configured to calculate, in addition to the orientation angle, a piece of information about the data quality of the orientation angle as a variance value and provides it to the fusion filter 105.

The fusion filter 105 uses the orientation angle and the variance of the orientation angle in its calculations and passes the calculation results on via the fusion dataset 106 to the strapdown algorithm unit 102. This means that the fusion filter 105 captures the measured values or values of the physical variables from the inertial navigation system 101, which is the basic sensor system, as well as from the odometry navigation system 103 and the satellite navigation system 104, which are the correction systems.

The error values are determined in the form of function blocks that are connected into rows and do not influence one another. The function blocks also do not influence the fusion filter 105. Each function block can include the error propagation calculation of any one or several calculation steps of the system based on the example. This structure allows a flexible, branching, and adjustable course of the signal path. It also models the application of correction values and of parameters from the propagation calculation.

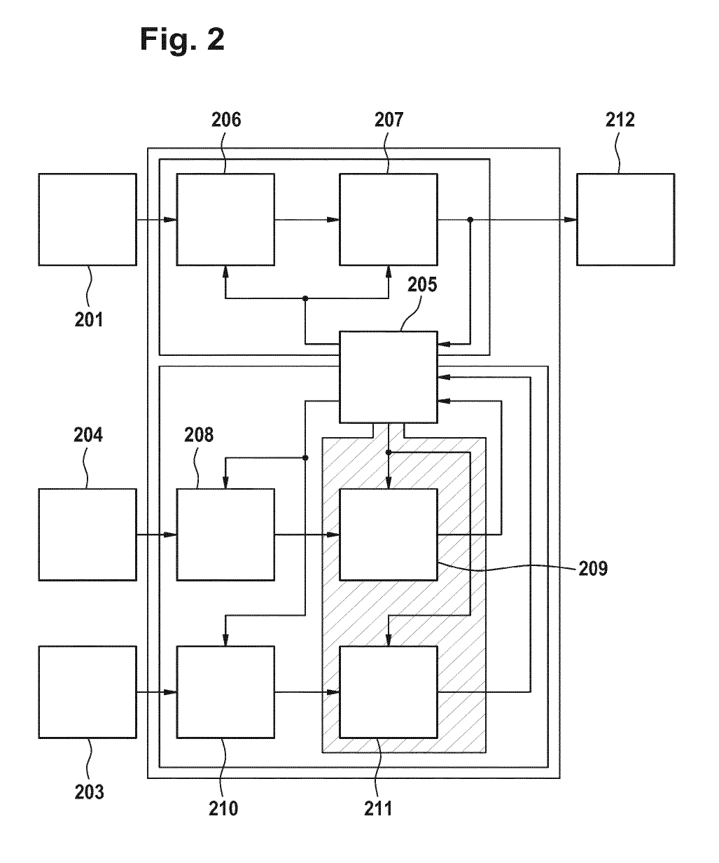

FIG. 2 shows an example of another possible embodiment of a system which is also configured for providing dynamic error values in real time in a motor vehicle (not shown). The system includes an inertial navigation system 201, a satellite navigation system 204, and an odometry navigation system 203 as different sensor systems. The inertial navigation system 201, the satellite navigation system 204, and the odometry navigation system 203 output measured values or values of the physical variables, which directly or indirectly describe navigation information, namely a position, a speed, an acceleration, an orientation, a yaw rate or yaw acceleration, to a fusion filter 205. The measured values or values of the physical variables are output via a vehicle data bus, on the basis of the example via a so-called CAN bus. On the basis of the example, the satellite navigation system 204 outputs its measured values or values of the physical variables in the form of raw data.

As a central element in determining the position of a motor vehicle, the inertial navigation system 201, which is a so-called MEMS-IMU (Micro Electro-Mechanical System Inertial Measurement Unit) is used that acts in combination with the strapdown algorithm unit 207, since it is presumed to be error-free, i.e. it is assumed that the measured values or values of the physical variables from the inertial navigation system 201 always correspond to their stochastic model, that they only show noise influences and are therefore free of external or accidental errors or disturbances. The noise and remaining non-modeled errors from the inertial navigation system 201, such as non-linearity, are assumed to be average free, stationary, and distributed normally across the measuring range (so-called Gaussian white noise).

The inertial navigation system 201 includes three rotation rate sensors that each detect orthogonally to one another and three acceleration sensors that each detect orthogonally to one another.

The satellite navigation system 204 includes a GPS receiver which initially performs distance measurements to receivable GPS satellites via the satellite signal propagation delay and also determines a path traveled by the motor vehicle from the change in signal propagation delay and additionally from the change in the number of wavelengths of the satellite signals. The odometry navigation system 203 includes one wheel speed sensor on each wheel of the motor vehicle and a steering angle sensor. The wheel speed sensors each determine the rotational speed of their associated wheel, and the steering angle sensor determines the applied steering angle.

The inertial navigation system 201 outputs its measured values or values of the physical variables to the preprocessing unit 206 of the inertial navigation system 201. The preprocessing unit 206 corrects the measured values or values of the physical variables or the navigation information described therein using corrections which the preprocessing unit 206 receives from the fusion filter 205. The measured values or values of the physical variables or the navigation information described therein corrected in this way are then passed on to the strapdown algorithm unit 207.

The strapdown algorithm unit 207 now determines the position based on the corrected measured values or values of the physical variables from the preprocessing unit 206. This position determination is a so-called dead reckoning based on the inertial navigation system 201. The preprocessing unit 206 constantly integrates or adds the corrected measured values or values of the physical variables it outputs or the navigation information described therein over time. The strapdown algorithm unit 207 also compensates a Coriolis force that acts on the inertial navigation system 201 and can affect the measured values or values of the physical variables of the inertial navigation system 201.

In order to determine the position, the strapdown algorithm unit 207 performs a double integration of the input data captured by the inertial navigation system 201, which describe accelerations, over time. This allows an update of the previously known position and an update of the previously known orientation of the motor vehicle. The strapdown algorithm unit 207 performs a single integration of the input data captured by the inertial navigation system 201 over time to determine a speed or rotation rate of the motor vehicle. Furthermore, the strapdown algorithm unit 207 corrects the determined position using respective correction values from the fusion filter 205. The fusion filter 205 only performs an indirect correction in this example, via the strapdown algorithm unit 207. The measured values or values of the physical variables or navigation information determined and corrected by the strapdown algorithm unit 207, i.e. the position, speed, acceleration, orientation, rotation rate, and rotational acceleration of the motor vehicle, are now routed to an output module 212 and to the fusion filter 205.

The strapdown algorithm executed by the strapdown algorithm unit 207 is not a very complex calculation and can therefore be implemented as a real-time basic sensor system. It represents a process flow for integration of the measured values or values of the physical variables from the inertial navigation system 201 regarding speed, orientation, and position and does not involve any filtering, such that the latency time and group delay are approximately constant.

The basic sensor system describes the sensor system whose measured values or values of the physical magnitude of the measured values or values of the physical variables of the other sensor systems, the so-called correction systems, are corrected. Based on the example, the correction systems are the odometry navigation system 203 and the satellite navigation system 204, as mentioned above.

Inertial navigation system 201, preprocessing unit 206 of the inertial navigation system 201, and strapdown algorithm unit 207 together form the basic sensor system, which proportionately also includes the fusion filter 205.

The output module 212 passes the navigation information determined and corrected by the strapdown algorithm unit 207 to any other desired systems of the motor vehicle.

The measured values or values of the physical variables detected by the satellite navigation system 204 are passed on via a so-called UART data connection, first to the preprocessing unit 208 of the satellite navigation system 204. The preprocessing unit 208 now uses the measured values or values of the physical variables output by the satellite navigation system 204, which represent raw data and include a description of the orbit of the GPS satellite that sends the GPS signals, to determine, a position and a speed of the motor vehicle in the GPS coordinate system. In addition, the satellite navigation system 204 determines a speed of the motor vehicle relative to the GPS satellite from which the signals are received. Furthermore, the preprocessing unit 208 corrects a time-base error contained in the output data of a receiver clock of the satellite navigation system 204, which is produced due to a drift of the receiver clock, and it corrects the changes in signal propagation delay and signal path caused by atmospheric influences on the GPS signals sent by the GPS satellite using a correction model. The time-base error and the atmospheric influences are corrected using correction values received via the CAN bus from the fusion filter 205.

Also, assigned to the satellite navigation system 204 is a plausibility check module 209, which checks the measured values or values of the physical variables of the navigation information output by the preprocessing unit 208, i.e. the position and speed of the motor vehicle, for plausibility. The input data that are plausibility checked by the plausibility check module 209 are then output to the fusion filter 205.

A preprocessing unit 210 of the odometry navigation system 203 receives the measured values or values of the physical variables detected by the odometry navigation system 203 via the CAN bus. The detected measured values or values of the physical variables are the output data of each wheel speed sensor and the output data of the steering angle sensor. The preprocessing unit 210 now determines the position and orientation of the motor vehicle in the motor vehicle coordinate system from the measured values or values of the physical variables output by the odometry navigation system 203 using a so-called dead reckoning method. Furthermore, the speed, acceleration, rotation rate, and rotational acceleration of the motor vehicle are determined, also in the motor vehicle coordinate system. In addition, the preprocessing unit 210 corrects the measured values or values of the physical variables received from the odometry navigation system 203 using correction values received from the fusion filter 205.

Also, assigned to the odometry navigation system 203 is a plausibility check module 211, which checks the measured values or values of the physical variables output by the preprocessing unit 210, i.e. the position, orientation, speed, acceleration, rotation rate, and rotational acceleration of the motor vehicle, for plausibility. Since the error values of the output data from odometry navigation system 203 often are accidental environment-related disturbances which are not white noise, e.g. if the wheel slip is comparatively high, the measured values or values of the physical variables determined using the inertial navigation system 201 and the satellite navigation system 204 are used to check the measured values or values of the physical variables from the odometry navigation system 203 for plausibility.

Initially however, the measured values or values of the physical variables are adjusted against a sensor-specific model assigned to them, which takes measuring uncertainties such as noise effects into account. If the measured values or values of the physical variables correspond to the model within the given limits or tolerance ranges, a first plausibility check is performed here and the plausibility-checked values are then processed further. The plausibility-checked measured values or values of the physical variables are then passed on to the fusion filter 205. If no plausibility check of these measured values or values of the physical variables can be performed, the respective measured values or values of the physical variables are discarded and not processed any further.

On the basis of the example, the fusion filter 205 is designed as an error state space Kalman filter. On the basis of the example, it is the main task of the fusion filter 205 to correct the measured values or values of the physical variables of the basic sensor system, that is, the inertial navigation system 201, using measured values or values of the physical variables n from the odometry navigation system 203 and satellite navigation system 204, which are the correction systems, or to output respective correction values to the strapdown algorithm unit 207. Since the inertial navigation system 201 is assumed to be free of accidental errors and external disturbances, the measured values or values of the physical variables from the inertial navigation system 201 are only subject to white noise.

Since the fusion filter 205 is a error state space Kalman filter, it determines the quantitative error values of the measured values or values of the physical variables and makes the respective corrections. This simplifies and speeds up the fusion of the measured values or values of the physical variables or error values from the inertial navigation system 201, the odometry navigation system 203, and satellite navigation system 204 into a joint fusion dataset performed by the fusion filter 205. This allows position determination and correction of the position determination in real time.

The system shown in FIG. 2 represents a so-called virtual sensor, however, the inertial navigation system 201, the odometry navigation system 203, and the satellite navigation system 204 are not parts of the virtual sensor. A virtual sensor is a system which will always generate the same output data or outputs regardless of the type of sensor systems included in it. In this example, the inertial navigation system 201, the odometry navigation system 203, and the satellite navigation system 204. It is not apparent from the output data or outputs which sensor systems are included in the system.

The error propagation calculation is configured as a row of function blocks connected in series in the system shown in FIG. 2 as well. The division into a row of function blocks allows easy and flexible adaptation of the processing steps at any time. Furthermore, the intermediate results at the output of each function block can be used. Branches and the influence of other parameters and corrections, e.g. of function filter 205 filter, can be added without changing the overall modeling. For example, the output data are used as input parameters for filtering.

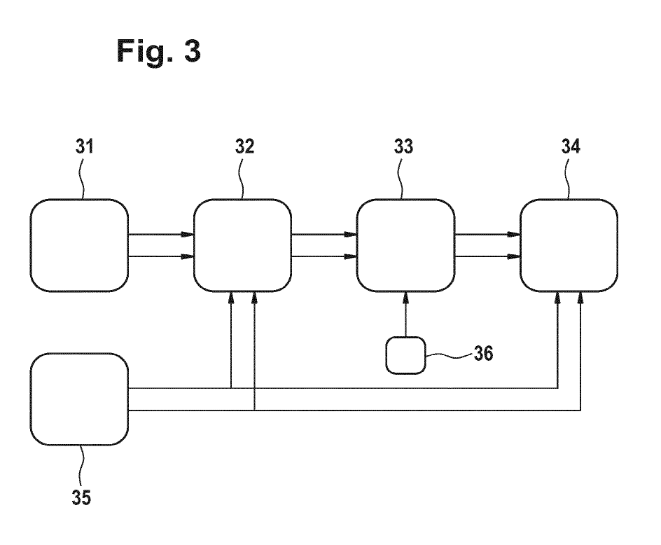

FIG. 3 shows an exemplary setup of function blocks 31, 32, 33, and 34 connected in a row. For example, a classification into different error types is made. In this way the overall error is split into individual errors. The accuracies assigned to each error type are called description variables below. Calculation and passing on of the description variables to user functions allows a function-specific evaluation of the measured values or values of the physical variables. Classification into description variables provides additional information, the sum total of the individual errors equals the overall uncertainty or overall error.

The processing of measured values or values of the physical variables is performed step by step, but always based on fundamental operations. The measured values or values of the physical variables are output from intermediate steps for this purpose. A concept for the accuracy measure as a data sheet calculated in real time for the virtual sensor exceeds beyond sole modeling as variances in the fusion filter 35. It results in the use of multiple characteristics for describing measured values or values of the physical variables. The result is, as shown, the motivation for dividing the signal processing performed into closed function blocks 31, 32, 33, and 34 modeled as black boxes, which always have the same input and output vector of the physical variables.

Within the function blocks 31, 32, 33, and 34, the physical variables are calculated in the form of an error propagation, which also takes into account known dependencies on physical variables in the form of an error propagation law. Otherwise, the physical variables are simplistically viewed as independent and non-interacting. This means that, in the error propagation calculation of a single physical variable, all uncertainties already modeled in another description variable and assumed to be independent are set to zero. Optionally, other parameters, for example obtained by corrections by fusion filter 35, are used for calculating the physical variables. Error propagation is here brought back to the basic operations of the data processing system used.

Modeling of the signal path starts with the sensor systems as sources, the respective physical variables are used as starting values in accordance with the specifications of the sensors in their real data sheets. Assuming correct modeling of the uncertainties in fusion filter 35, specification of the signal properties always corresponds to the current operating status at each process step of signal processing. The continuity risk of fusion filter 35 with respect to the compliance of these specifications corresponds to the continuity risk of the basic sensor system of IMU and strapdown algorithm, since, based on the example, their availability and compliance with specifications represent the smallest required basis for the operation of the fusion filter 35.

The physical variables are determined based on the requirements of the user functions, and these can be selected arbitrarily due to non-interaction with the fusion filter 35. A specific error propagation law is selected for each property for the calculation method. In principle, the error propagation calculation can be performed with any distribution functions that are specific to the physical variables.

The error values measuring noise, zero point error (offset), and pitch error (scale factor error) are selected here for the exemplary implementation of an accuracy measure in fusion filter 35 that meets the criteria required by the example.

The basic operations for the fusion filter 35 that is implemented, for example, in the form of a digital, time and value discrete system are: addition/subtraction, multiplication/division, and delay by one scanning step/storage.

In the application shown here as an example, it is further assumed that the physical variables are normally distributed. This simplifies the joint use with the stochastic model of fusion filter 35. The error propagation calculation can be represented in the case of uncorrelated physical variables for linear functions and transformations by a simple variance propagation. In the case of correlated physical variables, a variance propagation law with a completely filled variance-covariance matrix must be used.

One embodiment of the method is used for example for the correction of the zero point and scale factor error of an acceleration measurement 31 by fusion filter 35, its rotation 33 in navigation coordinates by the rotation matrix 36 and its summation into a speed 34 and a simultaneous correction 32 of the absolute value by fusion filter 35. These basic equations form the function blocks for describing the signal path. For the sake of clarity, it is assumed in this example that errors of the rotation matrix 36 and a scan interval, as well as general influences and errors of Coriolis acceleration and the estimated acceleration due to gravity can be neglected. However, these assumptions for 36 as a filter-corrected physical variable are not permissible for a complete accuracy description of the basic sensor system.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A method for providing dynamic error values of dynamic measured values in real time for a sensor system comprising:
detecting measured values using at least one sensor system, wherein the measured values describe values of physical variables in one of a direct and indirect manner;
calculating values of indirectly described physical variables from at least one of the measured values, known physical relationships, and mathematical relationships;
determining step by step the error values of the measured values from the at least one sensor system in function blocks, which are influentially independent from one another and are connected to form rows; and
handling the error values in the function blocks as mathematical matrices.

2. The method according to claim 1, further comprising performing an error propagation calculation for each of the function blocks.

3. The method according to claim 2, further comprising individually characterizing the error propagation calculation performed in each function block by one of: the respective sensor systems and the respective physical variables.

4. The method according to claim 1, further comprising merging one of the measured values and the error values into a fusion dataset by data fusion.

5. The method according to claim 4, further comprising correcting the values that are merged into the fusion dataset.

6. The method according to claim 4, further comprising assigning the error values on a proportionate basis to the values of physical variables in the fusion dataset.

7. The method according to claim 1, wherein static fault characteristics of the sensor systems each represent a first function block in a row, and wherein at least one row starts from each first function block.

8. The method according to claim 1, wherein the function blocks each provide the raw data for one of: the other function blocks and applications based on the at least one sensor system.

9. The method according to claim 1, wherein the error values include one of: measurement noise, a zero point error, and a scale factor error.

10. The method according to claim 1, wherein at least one row of connected function blocks bifurcates in that the output of a function block branches off for further processing of the output data of the function block by other function blocks.

11. The method according to claim 1, wherein the measured values are at least one of: measured values of an inertial sensor system, measured values of a global satellite sensor system, and measured values of an odometry sensor system.

9. A system for providing dynamic error values of dynamic measured values of a sensor system in real time, comprising:
at least one sensor system, which detects measured values, wherein the measured values directly or indirectly describe physical variables;
a fusion filter which calculates the values of indirectly described physical variables from one of the measured values, known physical connections, and mathematical connections;
a fusion dataset created from the measured values which are merged by the fusion filter using data fusion; and
mutually non-interacting function blocks connected in rows, wherein the function blocks determine the error values in step by step manner and die error values in the function blocks are handled as mathematical matrices.

11. The system of claim 10, wherein the system is in a motor vehicle.

12. The system of claim 10, wherein the function blocks each perform an error propagation calculation.

13. The system of claim 12, wherein the error propagation calculation is individually characterized by one of: the respective sensor systems and the respective physical variables.

14. The system of claim 10, wherein one of the measured values and the error values are merged into a fusion dataset by means of a data fusion.

15. The system of claim 14, wherein the merged values in the fusion dataset are corrected.

16. The system of claim 14, wherein the error values are assigned at least on a proportionate basis to the values of physical variables in the fusion dataset.

17. The system of claim 10, wherein static fault characteristics of the sensor systems each represent a first function block in a row, wherein at least one row starts from each first function block.

18. The system of claim 10, wherein the function blocks each provide the raw data for one of other function blocks and for applications based on the sensor systems.

19. The system of claim 10, wherein the error values include one of: measurement noise, a zero point error and a scale factor error.

20. The system of claim 10, wherein at least one row of connected function blocks bifurcates in that the output of a function block branches off for further processing of the output data of the function block by other function blocks.

21. The system of claim 10, wherein the measured values are at least measured values are from one of: an inertial sensor system, a global satellite sensor system, an odometry sensor system.
